(19) United States
(12) Patent Application Publication
(10) Pub. No.: US 2006/0242247 A1
(43) Pub. Date: Oct. 26, 2006

(54) Methods and systems for integrating physical mail with electronic mail

(76) Inventor: Ric Bailier Richardson, Huntington Beach, CA (US)

Correspondence Address: PATENTMETRIX, 14252 CULVER DR. BOX 914, IRVINE, CA, 92604, US

(21) Appl. No.: 11/111,039

(22) Filed: Apr. 21, 2005

(51) Int. Cl. G06F 15/16

(52) U.S. Cl. 709/206

(57) ABSTRACT

The present invention discloses a method and system for integrating physical mail and electronic mail, such that it enables delivery of documents in electronic as well as physical form. In one embodiment, the present invention is a method for enabling the sending of physical mail to a recipient upon receipt of electronic mail from a sender. In another embodiment, the present invention comprises a system for enabling the sending of physical mail to a recipient upon receipt of electronic mail from a user comprising a server coupled to the network for receiving said email from at least one computing device wherein the computing device is associated with the user and coupled to a network and wherein the computing device operates an email program for creating an email message such that a physical mailing address of the recipient is capable of being embedded in a header of said email message and a parser located at the server that parses said email message header to retrieve the physical mailing address of the recipient.

### FIELD OF THE INVENTION

The present invention is related generally to the field of mail services and, more specifically, to methods and systems that allow for the integration of an electronic mail infrastructure with an existing physical mail infrastructure.

### BACKGROUND OF THE INVENTION

Electronic mail or “email” is one of the most popular communication mediums and is used to facilitate communication between a plurality of users of a computer network. Each user in the computer network has assigned to him or her a unique network address which is typically used by an email server for routing and identifying an email message from one user (the “sender”) to another user (the “recipient”) on the network.

Conventional email systems also have a provision for sending, along with the email message, one or more additional files of data, called “attachments,” which may be opened, accessed, or utilized separately from the email message itself. Attachments shall refer to any and all files or data that may be associated with an email message, including, but not limited to, files having the following formats: of .html/.htm, .txt, .doc, .pdf, .ps, .arc, .arj, .bin, exe, .gz/gzip, .hqx, .sit, .sea, tar/.tar.gz/.tar.Z/.tgz, .uu, .Z, .zip, gif, .jpg/jpeg/jfif, tiff, gif, au/uLaw/MuLaw, .aiff, .mp3, .ra, .wav, .avi, mov/.movie, .mpg/mpeg, .qt, .ram.

Although email offers a fast and efficient communication medium and, to some extent, has replaced conventional mailing services, such as the U.S. Postal Service, and private mailing services, such as Federal Express or UPS, it is often necessary to send documents in physical form rather than, or in addition to, electronic form. As defined herein, documents in physical form refer to any information or data that is embodied in a tangible form (i.e. as an envelope, paper of different stock sizes, postcards, etc.) such that the information or data can be viewed without the use of a computing device. Physical mailing addresses refer to physical locations to which a document in physical form can be delivered.

For example, important documents such as court orders, wills, adoption papers, insurance documents, notices, and government communications are still required to be in paper form to establish their authenticity, as the electronic forms of these documents may not be considered valid for legal purposes. Correspondence involving such documents inevitably necessitates using conventional methods such as mailing by post or by courier.

The need for physical mailing is further sustained by the fact that there are large segments of the population, both within the U.S. and outside the U.S., who do not have reliable or convenient access to electronic mailing facilities. Furthermore, many people access email only at their work places where there are often restrictions on receiving personal mails on official email addresses and also on the size and content of attachments. Also, many work places allow their employees to communicate via email only with a specified list of email addresses. The use of firewalls to block mails from unknown email addresses is a common security measure employed by corporate email systems. Finally, given the amount of electronic junk mail being communicated and the tendency for people to ignore such email, marketers may want to transmit such offers, advertisements, coupons, and notices by physical mail where they may have a greater likelihood of being viewed. All of the aforementioned situations call for using physical mail rather than electronic mail.

While physical mail may be a necessary or preferred mode of communication vis-a-vis electronic mail, it is more inconvenient and costly. Creating a physical mail package requires printing out the document to be mailed, creating the physical mail package, and transferring possession of the package to a courier. In addition to the extra time required to do so, there is a substantial cost to mailing or couriering a physical package. That cost increases based on the distance the package is being sent. Therefore, a system that minimizes such costs and provides for greater convenience would be desired.

The system disclosed in U.S. Pat. No. 6,604,132 (the Hitt patent) attempts to address this problem by providing a specialized email message generating system in which a recipient information receiver receives physical mailing information from a user and generates an email header from that information. Once generated, the email with that header is then sent to a dedicated server, which extracts the physical mailing address information from the pre-formatted email header.

Such systems are impractical for several reasons. First, the system disclosed in Hitt requires a specialized recipient information receiver to be used or for existing email programs to be modified. Therefore, a user cannot simply use the innovation without first making some modification to his or her existing system. Additionally, it is not possible for a new user to simply send an email to the email receiving server and expect it to recognize and respond to the user's email to physical mail conversion request. This creates a substantial barrier for new users to adopt the systems and methods of that invention. Additionally, the systems and methods disclosed in Hitt fail to provide for certain physical mailing features.

There is therefore a need for methods and systems that take advantage of the speed, convenience and efficiency offered by electronic mail and, at the same time, enable the delivery of documents in physical form. What is also needed is a method and system, which, while integrating physical mail and electronic mail, also incorporates additional features such as the ability to conduct an email to physical mail conversion without having a specialized client program to do so, to send certified mail, insured mail, and registered mail, to tailor the physical mail package to a user's aesthetic needs, and to allow first time users to easily use the system.

### SUMMARY OF THE INVENTION

The present invention discloses a method and system for integrating physical mail and electronic mail, such that it enables delivery of documents in electronic as well as physical form. In one embodiment, the present invention is a method for enabling the sending of physical mail to a recipient upon receipt of electronic mail from a sender. The method comprises receiving, at a server, an email message from at least one computing device associated with the sender and coupled to a network wherein a physical mailing address of the recipient is embedded in a header of the email message, and parsing the email message header at the server to retrieve the physical mailing address of the recipient.

Optionally, the network is a distributed computing network. The computing device can be any one of a personal computer, laptop, personal data assistant, mobile phone, wireless email manager, media player, computing tablet, set-top box, and networked DVD player. Optionally, the email message has an attachment. Optionally, the physical mailing address retrieved at the server is optionally verified for accuracy by the sender.

Optionally, the step of parsing the email message header at the server to retrieve the physical mailing address of the recipient is followed by the step of converting the email message from electronic format to physical format. The step of converting the email message from electronic format to physical format further comprises presenting a preview of the physical format to the sender and modifying the physical format in accordance with inputs from the sender.

Optionally, the step of converting the email message from electronic format to physical format is followed by the step of sending the email message for physical delivery at the physical mailing address of the recipient. The mode for physical delivery is any one of ordinary mail, first-class mail, certified mail, registered mail, insured mail, priority mail and by courier. The steps of converting the email message from electronic format to physical format and sending the email message for physical delivery are carried out at one of a plurality of sites, such that said one of a plurality of sites is geographically proximate to the physical mailing address of the recipient.

In another embodiment, the present invention comprises a system for enabling the sending of physical mail to a recipient upon receipt of electronic mail from a user comprising a server coupled to the network for receiving said email from at least one computing device wherein the computing device is associated with the user and coupled to a network and wherein the computing device operates an email program for creating an email message such that a physical mailing address of the recipient is capable of being embedded in a header of said email message and a parser located at the server that parses said email message header to retrieve the physical mailing address of the recipient.

In another embodiment, the present invention comprises a computer program product for enabling the transmission of physical mail to a recipient based upon the receipt of electronic mail, the computer program product comprising computer readable program code for parsing a header of an email message to retrieve a physical mailing address of the recipient embedded therein and computer readable program code for converting said email from electronic format to physical format.

### BRIEF DESCRIPTION OF THE DRAWINGS

These and other features and advantages of the present invention will be further appreciated, as they become better understood by reference to the detailed description when considered in connection with the accompanying drawings:

FIG. 1 is a diagram depicting the system of the present invention according to a preferred embodiment;

FIG. 2a is a diagram illustrating a conventional email message interface;

FIG. 2b is a diagram illustrating an email message interface of the present invention;

FIG. 3 is a flowchart illustrating the overall operation of the mail system of the present invention;

FIG. 4 is a diagram depicting a plurality of major components of an exemplary mail processing software according to one embodiment of the present invention;

FIG. 5 is a diagram depicting the structure of an exemplary parser module; and

FIG. 6 is a diagram illustrating the mail system and its operation, according to another embodiment of the present invention.

### DETAILED DESCRIPTION OF THE INVENTION

The present invention discloses a method and system for integrating physical mail and electronic mail, such that it enables delivery of documents in electronic as well as physical form. Various modifications to the preferred embodiment will be readily apparent to those of ordinary skill in the art, and the disclosure set forth herein may be applicable to other embodiments and applications without departing from the spirit and scope of the present invention and the claims appended hereto. Thus, the present invention is not intended to be limited to the embodiments described, but is to be accorded the broadest scope consistent with the disclosure set forth herein.

As used herein, the term computing devices broadly encompasses any type of computing device that could be placed in data communication with a network. For example, the computing device could be any one of a personal computer, laptop, personal data assistant, mobile phone, wireless email manager, media player, computing tablet, set-top box, networked DVD player, or other type of network access device. Each of said devices has a processor, memory, and a communication interface, such as a modem or Ethernet port. Similarly, the term network broadly encompasses any type of network, including local area networks, wide area networks, metropolitan area networks, and wireless networks based on infrared, bluetooth, wide area data, cellular telephony, WLAN, paging, or satellite technology.

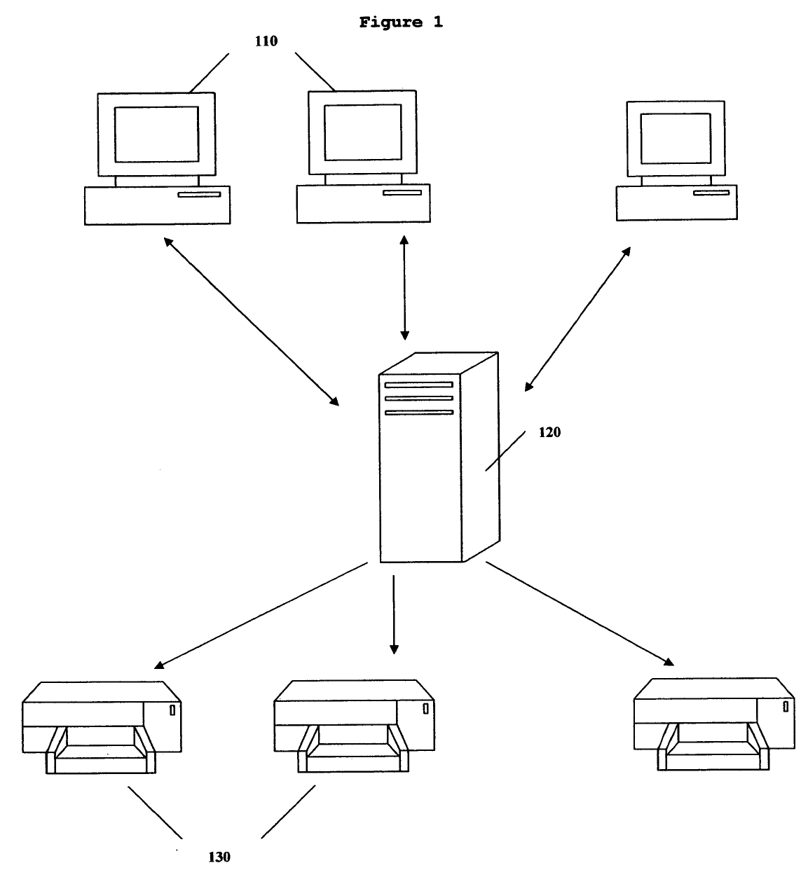

Referring to FIG. 1, an embodiment of the system of the present invention is shown. The system consists of a plurality of computing devices 110, a central server 120, and a plurality of peripheral systems 130, connected to a distributed computing network such as the Internet.

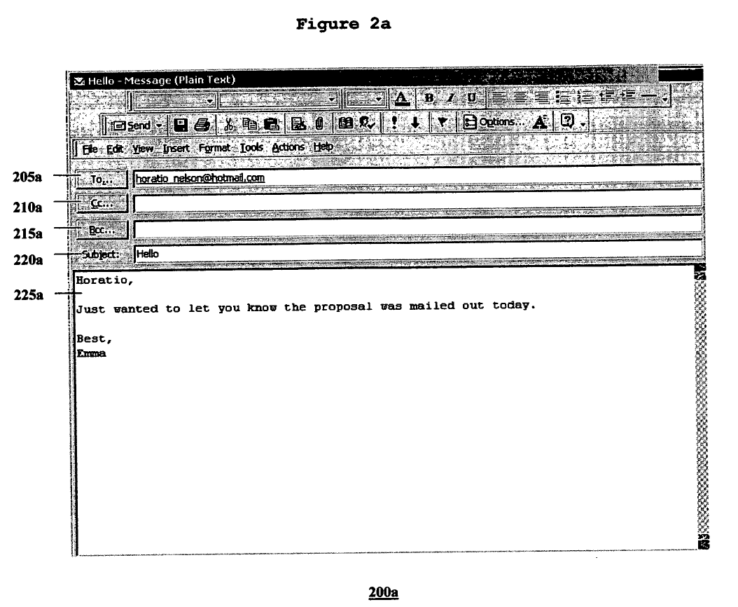

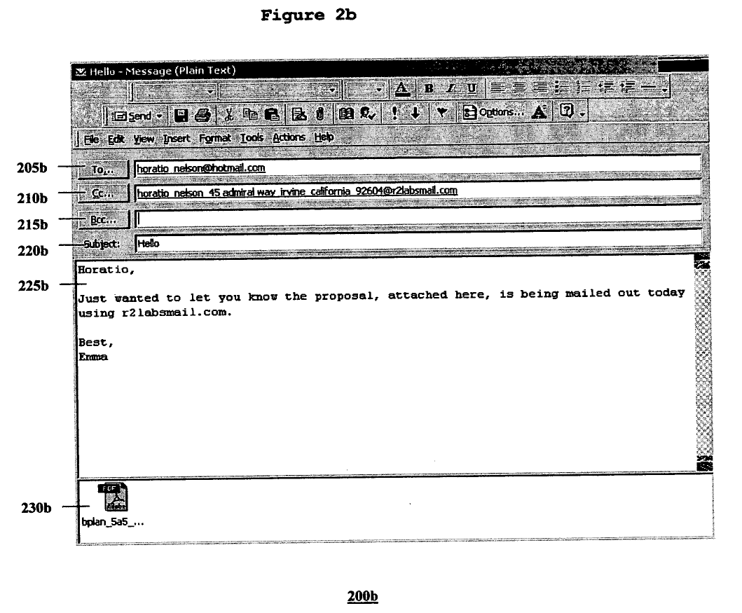

Users connected to the network make use of computing devices 110 to send and receive emails. If a user wishes to send mail in only electronic format, it is routed via the email server (not shown) associated with the domain name specified in the recipient's email address. For example, if the recipient's name is Horatio Nelson and his email address is Horatio_Nelson@hotmail.com, then any email sent to Horatio's email address is first routed to the server that is assigned to one or more of the IP addresses designated by name “Hotmail”. In order to retrieve that email, Horatio would connect to the Hotmail server using his computing device. FIG. 2a presents a diagram of a typical email message interface 200a comprising a conventional email address input line 205a, a cc email address input line 210a, a bcc email address input line 215a, a subject input line 220a, and a message 225a.

If a user wishes to send mail in a physical format using email, or in a physical format as well as in electronic format, then at least one of the email address inputs needs to include an email address corresponding to a server capable of performing an email to physical mail conversion.

In one embodiment, shown in FIG. 2b, email message interface 200b comprises an email address input line 205b, a cc email address input line 210b, a bcc email address input line 215b, a subject input line 220b, a message 225b, and an attachment 230b. Here, a first user (sender) intends to deliver an email message to a second user (recipient) having the email address horatio_nelson@hotmail.com. In addition, the first user intends to have the attachment 230b sent in both email form and physical form. To effectuate the sending of attachment 230b in physical form, first user includes a physical mail routing address, provided in cc email address input line 210b. The physical mail routing address transmits email 200b, together with attachment 230b, to the designated domain, r2labsmail.com where the email to physical mail conversion will occur.

One of ordinary skill in the art would appreciate that the email interface 200b is a conventional email interface and has not been modified to require any special data input fields, devices, modules, or other routines. While such input elements are not outside the scope of this invention, it is preferred that existing, conventional client-based email message interfaces, such as Microsoft's Outlook, or web-based email message interfaces, such as Yahoo.com or Hotmail.com do not have to be modified in order to be compatible with the present invention. It should further be appreciated that, while FIG. 2b depicts the transmission of a message to a second user along with the transmission of a message to the physical mail routing address, it is not necessary to send an email message to the physical mail recipient to practice this invention. It should further be appreciated, as discussed below, that the physical mail routing address can use any domain name and is not bound by the specific name, r2labsmail.com, detailed herein.

The physical mail routing address comprises a header and a domain. The domain name can be any conventional domain name and, preferably, incorporates the nature of the physical mailing service being requested in the domain name. For example, where a user wishes the physical mailing service to be regular first class mail, the domain can be structured as @firstclass.anyname.com or @anynamefirstclass.com. Similarly, if the user wishes the physical mailing service to be second class mail, the domain is structured as @ secondclass.anyname.com or @anynamesecondclass.com. If the user wishes the physical mailing service to be bulk mail, the domain is structured as @ bulkmail.anyname.com or @anynamebulkmail.com. If the user wishes the physical mailing service to be bulk mail, the domain is structured as @bulkmail.anyname.com or @anynamebulkmail.com. If the user wishes the physical mailing service to be certified mail, the domain is structured as @certified.anyname.com or @anynamecertifiedmail.com. Other physical mailing services can be similarly structured (i.e. @anynameregisteredmail.com for registered mail, @anynameexpressmail.com for express mail, etc.). One of ordinary skill in the art would appreciate that “anyname” represents any acceptable domain name, in accordance with standard SMTP and Internet protocols. One would also appreciate that the inclusion of the service class can happen anywhere in the domain name and can use other terminology. Further, one would appreciate that the inclusion of the service class, or other mail service information, can happen in the header. For example, an acceptable service class designation can be physical_address_certifiedmail@anyname.com or physical_address_anyserviceclass@anyname.com.

To enable physical delivery via the email to physical mail conversion server, the email header should include the physical mailing address of the user. Thus, for example, if John Smith, the recipient, has the following physical address—John Smith, 123, Main St.Hawthorne, Calif. 90234, then the sender may specify the physical address as John_Wills_{—}123_Main_St._Hawthorne_Calif._{—}90234@firstclassmail.anyn ame.com, where “anyname” is an exemplary domain name for the central server that enables physical delivery of the mail. Thus the physical address of the recipient is incorporated into an email address header.

Optionally, the email header is structured as a physical address where words, numbers, or phrases are separated by a first character and lines, such as those conventionally separating a name, street address, and city, are separated by a second character. In one embodiment, words, numbers, or phrases in a physical address are separated by a symbol, such as an underscore, ˜, +, or any other symbol that is capable of being recognized by a conventional email server. In another embodiment, lines in a physical address are separated by a symbol, such as an underscore, ˜, +, or any other symbol that is capable of being recognized by a conventional email server. Where the service class is included in the header, a third character can be used to separate the service class designation, such as an underscore, ˜, +, or any other symbol that is capable of being recognized by a conventional email server.

When an email message carrying the aforementioned address in the “To” field is sent, the message is routed to the central server for further processing. Unlike other systems, the sender may specify the physical address in any format as long as the format includes a domain representing an email to physical mail conversion server.

The central server 120 hosts a software application, which is responsible for identifying the physical address from the received email message, converting the message into a physical format as desired by the sender and facilitating printing and mailing of the message. Once the software has identified the physical address from the message header, it issues appropriate instructions to any of the available peripheral systems 130. In one embodiment, the peripheral systems 130 comprise printing and/or mailing devices. Thus, the message is printed, packaged into an envelope carrying the physical address of the recipient and sent for physical delivery to the recipient.

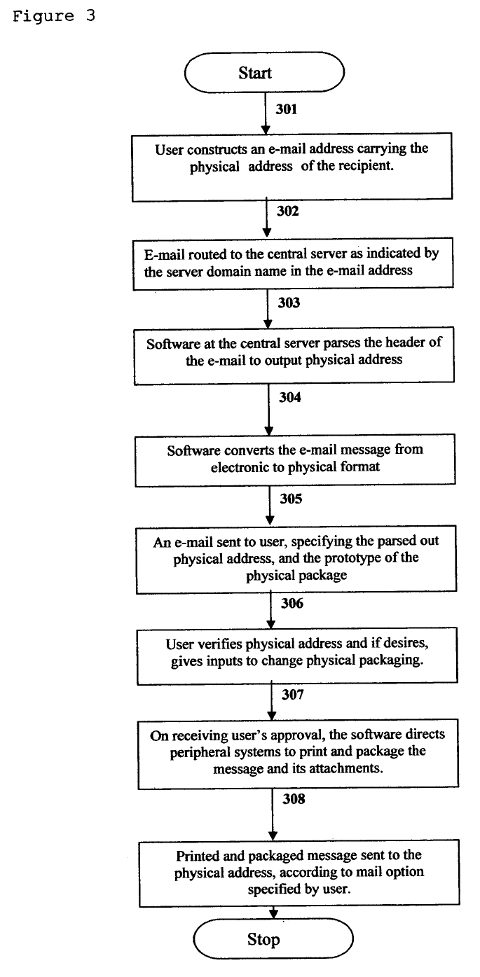

FIG. 3 depicts the operational flow of the mail system of the present invention, which was described in FIG. 1. Referring now to FIG. 3 (and referring back to FIG. 1), a user who wishes to send mail physically, operates a computing device that is in data communication with a distributed network such as the Internet. The users constructs an email address directed toward the central server 120 such that the email address carries the physical address of the intended recipient 301. As mentioned earlier, if John Smith is the recipient, an exemplary email address carrying John's physical address can be—John_Smith_{—}123_Main_St._Hawthorne_Calif._{—}90234@ firstclassmail.anyname.com. Alternatively, the user (sender) can designate any of a plurality of other mail service classes, including bulk, second class, third class, express overnight, express next business day, express Saturday delivery, express overnight morning delivery, registered mail, certified mail, insured mail, among other service classes.

Where a specific courier company is implementing the present invention, i.e. UPS or Federal Express, they can also include a proprietary service class in the domain portion of the email address. Alternatively, they can require the service class to be integrated into the header, which, in the course of parsing the header, is recognized by the email to physical mail conversion server as being a service class designation.

When the email message with the user defined email address that carries the physical address of the recipient and the specified mail options is sent, it is routed to the central server as indicated by the server domain name in the email address 302. The software hosted by the central server 120, parses the header of the received email message and outputs the physical address of the recipient 303.

Optionally, the system of the present invention creates a prototype of the physical mail package to be sent to the identified recipient and provides the sender of the mail package an opportunity to view the prototype, modify the prototype, correct errors, and/or approve the sending of the physical mail.

In one embodiment, referring back to FIG. 3, the email message and attachment are electronically packaged with an addressed envelope or package label. The resulting electronic package, optionally outputted in a tiff or PDF format, can be viewed to see, on a page-by-page basis, what the recipient will actually receive. For example, on page 1 of the presentation file, the package label or addressed envelope is presented. On page 2 of the presentation file, the email message is presented, if a desired part of the package. On other pages of the presentation file, the email attachment is presented. One of ordinary skill in the art would appreciate that any reliable viewing format can be used to present the prototype file.

In another alternative embodiment, the presentation file is automatically customized to the sender's specifications. For example, the central server can be programmed to recognize that any email messages and/or email attachments transmitted from a specific domains or from a specific email address should be formatted in a certain way. Specifically, email addresses associated with @anyuser.com or john@anyuser.com could be predesignated to have a certain settings for font color, size, and style, paper stock and color, letterhead content and design, and page layout, among other formatting settings. The predesignated settings could extend to how email messages are treated, i.e. whether they are discarded or printed out on a certain letterhead, and/or other options. Such predesignated settings could be established by having the user define the settings via a web interface hosted by www.anyname.com. One of ordinary skill in the art would appreciate that such a process encompasses any type of method to create user accounts, establish a payment method, and establish preference settings for a particular domain or a particular email address.

Alternatively, if the user does not have predesignated formatting settings or a pre-establish account, the central server can be programmed to create the presentation file using default settings for font color, size, and style, paper stock and color, letterhead content and design, and page layout, among other formatting settings. In one embodiment, the present invention does not provide a presentation file, prints the email and/or attachments in a default style or whatever style received, and mails the document(s) using a default style and stock for the label and packaging.

Whether the presentation file uses customized settings or default settings, one can optionally have the presentation file presented to the user for review, verification, and authorization. In one embodiment, the presentation file is immediately presented to the user for review, verification, and authorization. Upon sending the email, the user is presumed to have authorized the physical mailing based upon the presentation file.

In another embodiment, the central server sends an email (Verification Email) to the user to which is attached the prototype of the physical package 305. On receiving the Verification Email, the user is instructed to view the package and verify if a) the recipient address is correct and b) the package formatting is correct. In one embodiment, the user modifies the presentation file by clicking on a link embedded in the Verification Email message, going to the linked verification site, which is preferably a URL for a website associated with the central server, and logging in. Preferably, the logging in process is effectuated by typing in a reference number included in the Verification Email. In another embodiment, the user replies to Verification Email by a reply email that indicates the user's approval, i.e. through an OK in the body of the email or subject line or any other pre-designated form of approval, without requiring the user go to a website and log-in.

Optionally, the present invention can require verification only for certain service classes (i.e., overnight, certified, insured), certain size mailings (i.e. over a predesignated number of pages, such as 5), or certain number of mailings (i.e. if the system determines the same user sending multiple mailings).

For new users, the website requests the users create an account to provide improved service, establish formatting settings, and establish a billing method, i.e. a credit card that gets billed for each physical mail package sent. For existing users (or newly created users), the website permits them to view the presentation file and make edits in associated dialog boxes. For example, to modify the address label, the user is presented with a series of input fields that a pre-filled with the existing data. Users can change the address entries, or confirm the address entries, and go to the next elements requiring verification.

In one embodiment, the website offers an interactive interface, which besides allowing for modifying recipient's physical address, also provides the user with an option to define a particular packaging for physical mailing. The user interface enables the user to choose a plurality of design and appearance options, including, but not limited to the following:
a. Different types of letterheads, including user's own letterhead (by uploading a sample letterhead);
b. Color of paper;
c. Weight (stock) of paper;
d. Quality of printing
e. Font size, style and color; or
f. Envelope size, color and type (plain, windowed, printed, etc.)

In one embodiment, the user may select separate formatting for the email message and its attachments. After making the desired changes, the user is offered a preview or effectuates a preview by using a “print preview” option typically available in client applications. If satisfied, the user confirms that the message is ready to be sent 306.

On receiving the user's approval, the central server software directs any of the available peripheral systems 130 to print the message and its attachments, if any, in the format selected by the user 307. Besides printers, the peripheral devices may also comprise envelop stuffing machines for packaging the mail and postage meters for applying suitable postage, if required. After the mail has been printed and packaged, it is sent by courier or by post, depending on the mail option specified by user 308.

In one embodiment, the peripheral devices are located not only locally with respect to the central server, but also remotely, such that they are dispersed across several geographic locations and are connected to the central server by means of a distributed computing network. When the user approves of the package, the central server then locates the peripheral device closest to the recipient's address, city, state, zip code, or country. That peripheral device then receives the command to print, package, and post the physical mail. This ensures that the package is actually printed and mailed in geographic proximity to its intended destination, thereby avoiding interstate or international postage and delivery rates.

For example, if the sender is located in California, United States and wishes to send a mail physically to a recipient located in London, England, then the message gets printed in Great Britain, or more preferably in London, and is sent domestically within England rather than internationally from California to England. This feature of the present invention allows for utilizing the speed and cost-effectiveness of electronic mail, while at the same ensuring the delivery of message in a physical format.

As previously stated, to assist the users in making payments and to facilitate continued use of the mail service, users are encouraged to set up accounts with the website associated with the central server. Users can register with the website and make a one time payment using their debit or credit cards, instead of having to pay each time they wish to send a physical mail. An account may be created in advance, before making use of the mail service, or at the time of sending a physical mail. In the latter case, when the user receives a message asking for confirmation before the package is sent out, the message provides a link that takes the user through the account set up process.

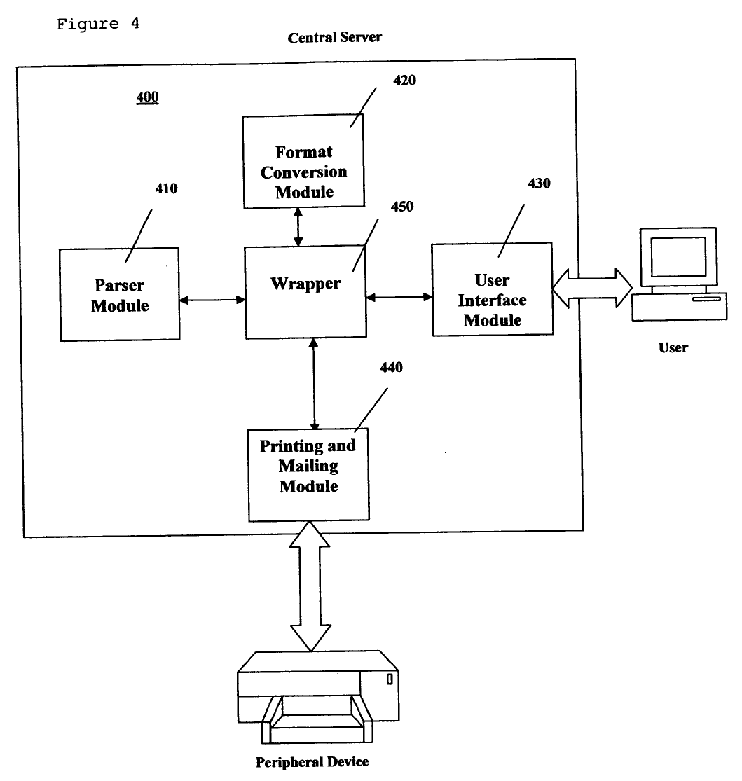

Referring to FIG. 4, major components of an exemplary mail processing software 400 located at the central server are depicted. One of ordinary skill in the art would appreciate that the software 400 can be installed on any computing device and be compatible with any operating system, including Java-based, Unix-based or Microsoft-based operating systems. One of ordinary skill in the art would also appreciate that the software 400 interfaces with the operating system of a computing device to communicate with processors, peripherals, data transmission, data reception, display and other hardware elements. The software preferably comprises a parser module 410, a Format Conversion module 420, a User Interface module 430, a Printing and Mailing module 440 and Wrapper 450.

The parser module 410 is responsible for extracting the physical address of the intended recipient from the header of the email message sent by the user to the central server. The Format Conversion module 420 converts the email message from electronic to physical format, as defined by the user. The User Interface module 430 interacts with the user to obtain inputs regarding the physical message format and styling, and also for verifying that the physical address obtained by the parser is correct. The inputs regarding message format and packaging are then used by the Format Conversion module 420 to make appropriate changes in message format. The User Interface module 430 also handles the account set up and user registration functions.

The Printing and Mailing module 440 directs the printing and mailing devices to generate the physical message according to the format specified by user and package it for mailing.

The wrapper 450 is a piece of program code that is responsible for coordinating the functions of various modules of the software. When the parser module 410 outputs the recipient's physical address, it is optionally passed on by the wrapper 450 to the User Interface module 430 for verification by the user. The physical address is passed on by the wrapper 450 to the Printing and Mailing module 440 to be put on the message envelope. Thus, the wrapper is responsible for passing information between modules and for calling the appropriate module depending on the functionality to be implemented. An exemplary wrapper program may be written using software programming languages C, C++ or JAVA, and utilizing object oriented programming (OOP) methodology.

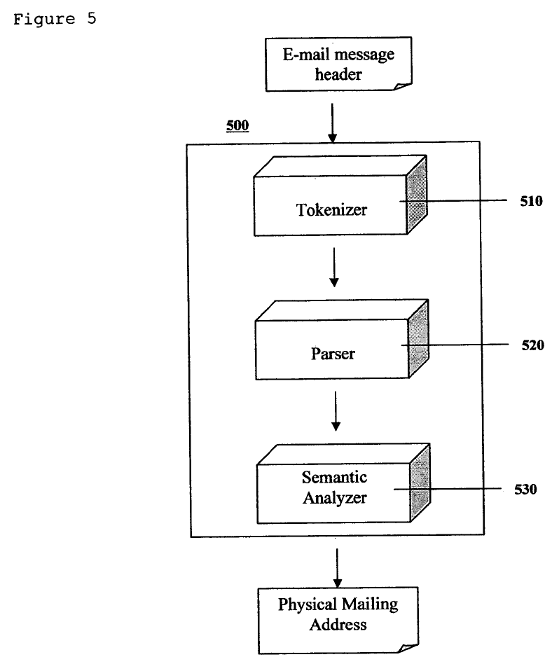

Referring to FIG. 5, the structure of an exemplary parser module is described. In one embodiment, the parser module 500 comprises a tokenizer 510, a parser 520 and a semantic analyzer 530. The header of an email message received at the central server, which contains the physical address of the intended recipient, is first passed through a tokenizer 510. A token is the smallest word or lexical unit that is understood to have some syntactic meaning. For example, in the email address John_Smith@hotmail.com, the lexical tokens are:

| | |
|---|---|
| John | (name) |
| | (special character-underscore) |
| Wills | (name) |
| @ | (special character-at) |
| hotmail | (domain name) |
| . | (special character-dot) |
| com | (expression representing commercial domain |
| | name) |

Thus, the tokenizer 510 takes the header text as input text divides into such basic units called tokens.

After tokenization, the tokens are supplied to the parser 520, which determines whether or not a series of tokens satisfies a set of defined rules. The parser 520 uses these rules to draw out the physical address of the intended recipient embedded in the email address of the message sent by the user to the central server. An exemplary set of rules to identify the physical address can include one or more of the following:
1. Whenever a non-number or a non-letter, that is, a special character, is encountered, it is considered to be a break in the header and indicates where names, addresses, or cities end and other information begins and ends.
2. Transitions from numbers to letters (and vice-versa) are also considered breaks in the header.
3. Recognizable sub-strings of known names and words are used to identify components of the physical address. For example, because “John” is a recognizable name, the system will assume a break should occur after it.
4. Strings following the special character “@” are not a part of the recipient's physical address.
5. Certain special characters, such as underscore, +, or ˜, can denote separations between words in a single line, between lines, or between an address and service class.

Thus, if the email header carries the address John_Smith+123_Main_St.+Hawthorne_Calif._{—}90234@ACMECO.mail.com, then using the aforementioned set of rules, the parser draws out the following set of strings:

Line 1: John Smith

Line 2: 123 Main St.

Line 3: Hawthorne Calif. 90234.

In this manner, the strings comprising the physical address are determined from the email address without requiring the client or web-based email program to have specialized software.

The set of strings output by the parser 520 are subject to test by the semantic analyzer 530, which verifies that the set forms a meaningful physical address. For example, if the user fails to mention any of the required information, such as the city name or the zip code, it is caught during semantic analysis. The user may then be asked to provide the necessary information during the verification process, as described above, or by a return email requesting additional information. In one embodiment, the semantic analyzer 530 compares parsed addresses to database directories containing known addresses. This may help improve the reliability of the system but, because an email-physical mail database is not required, the application is not unduly limited.

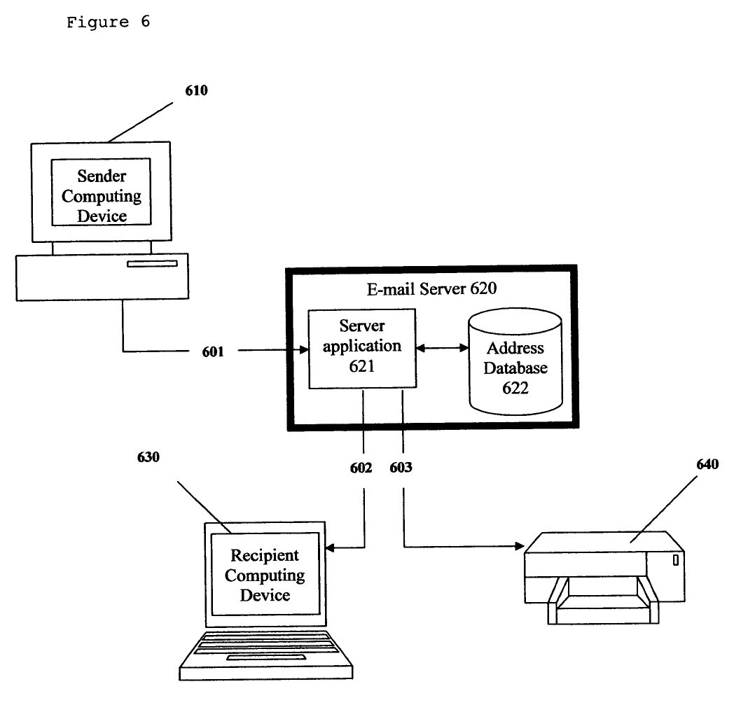

In another embodiment, the software that processes the email message header to extract the physical address and convert the message into physical format, takes the form of a generic application that can be hosted on any email server, rather than being located on a single central server. Such a system is illustrated in FIG. 6. The system comprises a sender computing device 610, an email server 620, a recipient computing device 630 and a peripheral device 640 for printing and mailing. The email server 620 further comprises application software 621 for message processing and optionally, an address database 622.

Also referring to FIG. 6, an email sent by the sender-computing device is routed 601 to the email server associated with the domain name specified in the email address. Thus, for example if the sender sends an email to John_Smith@hotmail.com, it is routed to the Hotmail server. From the server, the email is routed 602 to the recipient's computing device. This is electronic delivery of the message. If the sender also wishes to have the mail delivered physically, he or she specifies the physical address of the recipient in the same manner as described with reference to the first embodiment. However the domain name for the email address in which the recipient's physical address is embedded, remains the same as the one used for electronic delivery of the email. For example, in order to send an email physically to John Wills, whose email address is John_Wills@hotmail.com, the sender would specify John's physical address in an email address as: John_Wills+123_Main_St.+Hawthorne_Calif._{—}90234@mail.hotmial.com.

Thus, the same server is utilized for electronic delivery as well as physical delivery of the message, provided that the server hosts the software application. The software at the email server may provide for physical delivery of the message by ordinary mail or may provide various mailing options such as certified mail, insured mail, registered mail, etc depending on the available infrastructure.

On receiving a message intended for physical delivery, the software at the email server parses out the physical address of the recipient. Since in this case, the recipient is registered as a user with the email server, the server is likely to have the physical address of the user in its database. The server application software may optionally use this database to verify the correctness of the extracted physical address. After confirming the accuracy of the physical address with the user, the email message is printed, packaged and sent for mailing 603, using the peripheral device.

It should be noted that, while the present invention does not require a database of existing physical addresses to effectuate a physical mailing, the present invention can use any database to check the accuracy of a physical address presented in an email header. For example, where implemented by a company for its employees, the present invention can use a company's proprietary database of client, employee, or other contact names to check the accuracy of a mailing address. Third party databases can also be used, such those offered by whitepages.com or Yahoo.com, to check the accuracy of a mailing address. Where an address check is enabled, the present system transmits return email to the user asking the user if the inputted physical address was intended to correlate with a similar address identified in the database. The user then responds by either agreeing or correcting the physical address.

The aforementioned system is extremely useful for applications where it is required to send documents physically as well as electronically. For example, credit card companies, companies providing utilities such as electricity, water and phone, and other service providers send bills to their users' physical addresses as well as by email. Similarly, insurance companies also correspond with their customers by means of physical as well as electronic mail. With the aforementioned system, such companies need not spend time and effort in separately mailing the documents physically and electronically, as both the modes of delivery of documents may be accomplished using a single mail service.

The above examples are merely illustrative of the many applications of the system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A method for enabling the sending of physical mail to a recipient upon receipt of electronic mail from a sender, the method comprising:
receiving, at a server, an email message from at least one computing device associated with the sender and coupled to a network wherein a physical mailing address of the recipient is embedded in a header of the email message; and
parsing said email message header at the server to retrieve said physical mailing address of the recipient.

2. The method of claim 1, wherein the network is a distributed computing network.

3. The method of claim 1, wherein the computing device can be any one of a personal computer, laptop, personal data assistant, mobile phone, wireless email manager, media player, computing tablet, set-top box, and networked DVD player.

4. The method of claim 1, wherein said email message has an attachment.

5. The method of claim 1, wherein said physical mailing address retrieved at said server is optionally verified for accuracy by said sender.

6. The method of claim 1, wherein the step of parsing the email message header at the server to retrieve the physical mailing address of the recipient is followed by the step of converting said email message from electronic format to physical format.

7. The method of claim 6, wherein the step of converting said email message from electronic format to physical format further comprises:
presenting a preview of said physical format to the sender; and
modifying said physical format in accordance with inputs from said sender.

8. The method of claim 7, wherein the step of converting said email message from electronic format to physical format is followed by the step of sending said email message for physical delivery at the physical mailing address of the recipient.

9. The method of claim 8, wherein the mode for physical delivery is any one of ordinary mail, first-class mail, certified mail, registered mail, insured mail, priority mail and by courier.

10. The method of claim 8, wherein the steps of converting said email message from electronic format to physical format and sending said email message for physical delivery are carried out at one of a plurality of sites, such that said one of a plurality of sites is geographically proximate to the physical mailing address of the recipient.

11. A system for sending physical mail to a recipient upon receipt of electronic mail from a user, comprising:
a server coupled to the network for receiving said email from at least one computing device wherein said computing device is associated with the user and coupled to a network and wherein said computing device operates an email program for creating an email message such that a physical mailing address of the recipient is capable of being embedded in a header of said email message; and
a parser located at said server that parses said email message header to retrieve said physical mailing address of the recipient.

12. The system of claim 11, wherein the network is a distributed computing network.

13. The system of claim 11, wherein the computing device can be any one of a personal computer, laptop, personal data assistant, mobile phone, wireless email manager, media player, computing tablet, set-top box, and networked DVD player.

14. The system of claim 11, wherein said email comprises an attachment.

15. The system of claim 11, wherein said physical mailing address retrieved at said server is optionally verified for correctness with said user.

16. The system of claim 11, further comprising means for converting said email from electronic format to physical format.

17. The system of claim 16, wherein means for converting said email from electronic format to physical format further comprises:
means for presenting a preview of said physical format to the user associated with said at least one computing device; and
means for modifying said physical format in accordance with inputs from said user.

18. The system of claim 11, further comprising means for sending said email for physical delivery at the physical mailing address of the recipient, said means being located at a plurality of sites.

19. The system of claim 18, wherein the mode for physical delivery is any one of ordinary mail, first-class mail, certified mail, registered mail, insured mail, priority mail and by courier.

20. The system of claim 18, wherein means for sending said email for physical delivery is at least one peripheral device located in any one of a plurality of locations, such that said one of said locations is geographically proximate to the physical mailing address of the recipient.

21. A computer program product for transmitting physical mail to a recipient based upon the receipt of electronic mail, the computer program product comprising:
computer readable program code for parsing a header of an email message to retrieve a physical mailing address of the recipient embedded therein; and
computer readable program code for converting said email from electronic format to physical format.

22. The computer program product of claim 21, wherein computer readable program code for converting said email from electronic format to physical format further comprises:
computer readable program code for presenting a preview of said physical format to a user associated with said email; and
computer readable program code for modifying said physical format in accordance with inputs from said user.
